(19) United States
(12) Patent Application Publication
(10) Pub. No.: US 2010/0270721 A1
(43) Pub. Date: Oct. 28, 2010

(54) HOLDING DEVICE OF A TORQUE TESTER

(76) Inventor: Chzn-Pou Liu, Pitou Township (TW)

Correspondence Address: Wang Law Firm, Inc., 4989 Peachtree Parkway,, Suite 200, Norcross, GA, 30092, US

(21) Appl. No.: 12/428,579

(22) Filed: Apr. 23, 2009

(51) Int. Cl. B23Q 1/64

(52) U.S. Cl. 269/57

(57) ABSTRACT

A holding device of a torque tester is disclosed. The holding device is disposed on a platform, which has a driving device for the disposition of the working end of a torque wrench. The holding device holds the holder of the torque wrench. The holding device includes a board, a swinging body, and a sliding body. The board is disposed on the platform and has an axle element. The swinging body includes a bottom board with an axle hole for the axle element to go through. The swinging body is thus pivotally disposed on the board. Both sides of the bottom board are provided with a stop wall, respectively. The two stop walls and the bottom board form an accommodating passage. The sliding body slides inside the accommodating passage. The sliding body has a fixing structure to hold the holder. The sliding body is allowed to move inside the accommodating passage relative to the swinging body.

### BACKGROUND OF THE INVENTION

1. Field of Invention

The invention relates to a holding device of a torque tester and, in particular, to a holding device for holding the holder of a torque wrench.

2. Related Art

Generally speaking, a torque wrench has a certain torque value, which can be adjusted according to the tightness of a compressive spring therein. Before the torque wrench is sold, its torque value is usually tested and adjusted to ensure the quality.

Please refer to FIG. 7. In the torque test, the working end 61 of the torque wrench 6 is disposed on a driving device 71 of a platform 7. The holder 62 of the torque wrench 6 is fixed by two pinching parts 721 of the pinch base 72. The lower part of the two pinching parts 721 is fixed to a board 73. A motor drives the head part 711 to rotate the connector of the working end 61. When the output torque is over a predetermined value, the components inside the torque wrench break apart. Therefore, one can test its torque value.

However, when testing the torque value, the working end 61 and the holder 62 of the torque wrench 6 are both firmly held. Moreover, if the connector on the working end 61 of the torque wrench 6 breaks apart, vibrates, or pulls, the action almost directly applies to the test platform 7. In the long run, the precision of the test platform 7 will be reduced. That is, its test errors become larger. Eventually, this will affect the quality of torque wrenches.

Besides, the working end 61 and the holder 62 of the torque wrench 6 are both fixed during the test. This is different from the actual use. In the latter case, the working end is fixed whereas the holder end can rotate relatively. Thus, the test is not consistent with human operations and force exertion. Therefore, the test precision based on both ends of the torque wrench being fixed and no buffer design still has certain errors.

In conclusion, the prior art needs to be improved.

### SUMMARY OF THE INVENTION

An objective of the invention is to solve the above-mentioned problems and provide a new holding device of a torque tester. The holding device is designed to be rotatable and slidable. Therefore, the breaking apart, vibrations, and pulls during the test of torque wrenches can be appropriately transmitted and released. The test precision of the platform is thus not affected by these incidents.

Another objective of the invention is to allow the holder of torque wrench to perform rotating and sliding behaviors to some extent during the torque test. This can better simulate the real situation and achieve more precise measurements.

To achieve the above-mentioned objectives, the disclosed holding device is disposed on a platform that has a driving device. The driving device is used to hold the working end of a torque wrench. The holding device holds the holder of the torque wrench. Moreover, the invention has the following features:

The holding device has a board, a swinging body, and a sliding body. The board is put on the platform, and has an axle element on its top.

The swinging body includes a bottom board. The bottom board has an axle hole for the axle element to go through. The swinging body is thus pivotally disposed on the board. Both sides of the bottom board have a stop wall, respectively. The two stop walls and the bottom board form an accommodating passage.

The sliding body slides in the accommodating passage of the swinging body. Moreover, the sliding body has a fixing structure for holding the holder. The sliding body can action relative to the swinging body in the accommodating passage.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the disclosed holding device on the platform;

FIG. 2 is an exploded view of the holding device in FIG. 1;

FIG. 3 is a three-dimensional exploded view of the holding device in FIG. 2;

FIG. 4 is a cross-sectional view of the disclosed holding device that holds a holder;

FIG. 5 is a schematic top view showing that the sliding body slides in the accommodating passage during a torque value test of the torque wrench;

FIG. 6 is a schematic top view showing that the sliding body pushes the swinging body into rotation during a torque value test of the torque wrench; and

FIG. 7 is a schematic view of a conventional holding device on a test platform.

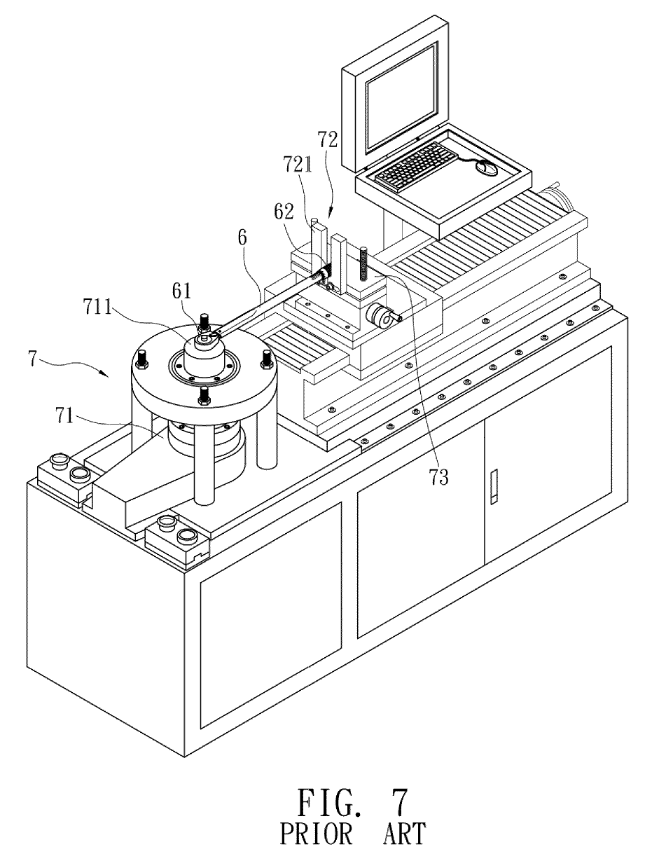

### DETAILED DESCRIPTION OF THE INVENTION

The present invention will be apparent from the following detailed description, which proceeds with reference to the accompanying drawings, wherein the same references relate to the same elements.

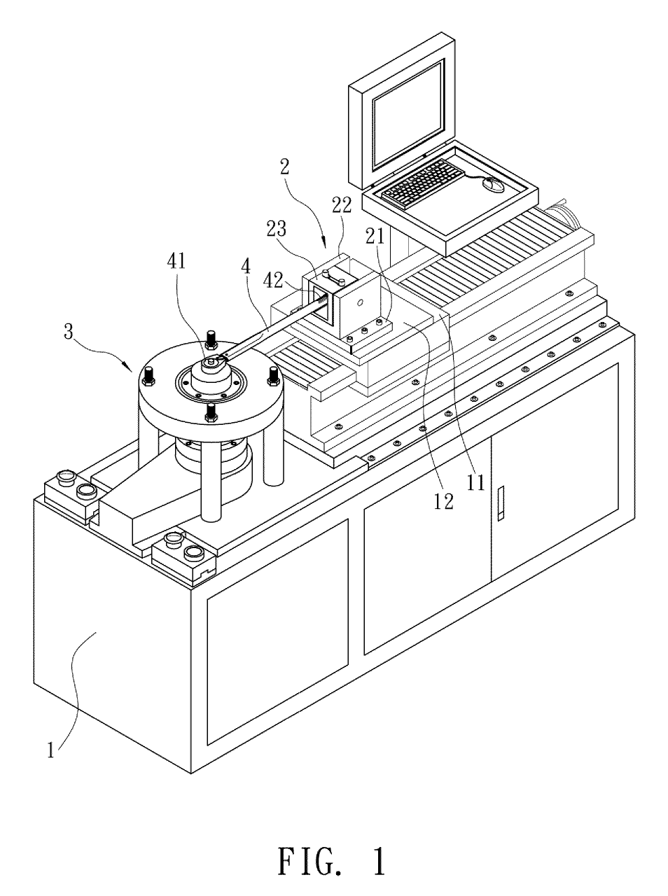

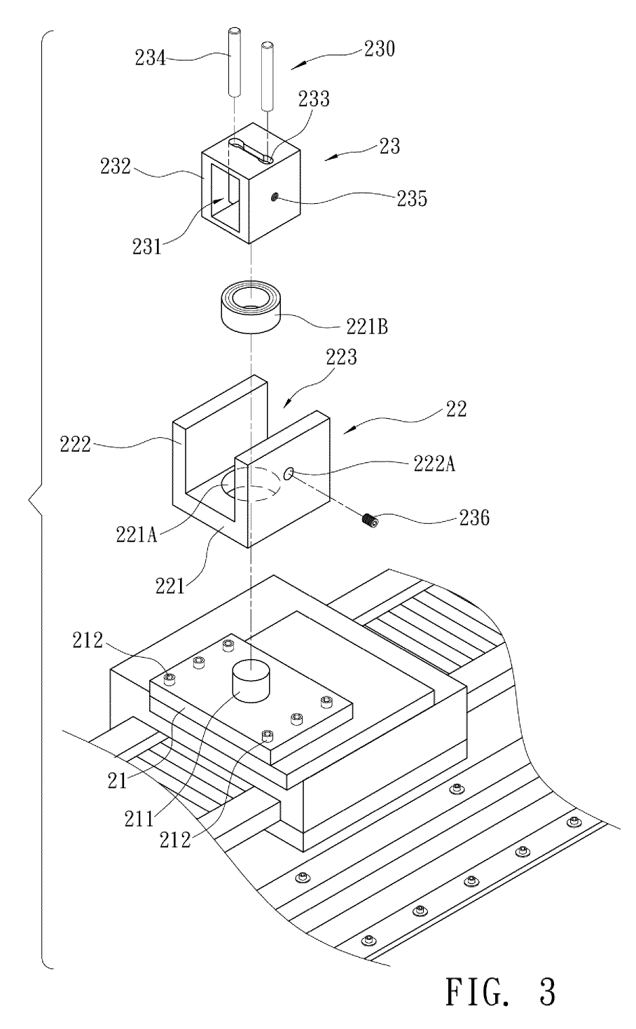

Please refer to FIGS. 1 to 3. The following description describes the embodiment of a holding device of a torque tester. The torque tester is used to test the torque value of a hand tool. In this embodiment, the hand tool is a torque wrench as an example. One side of a platform 1 is provided with a holding device 2. The other side of the platform 1 has a driving device 3 for the disposition of a working end 41 of a torque wrench 4. Of course, the driving device 3 includes a driving motor, a decelerator, and a head part that connects to the connector of the working end 41. This part belongs to the prior art and is not further detailed herein. The above-mentioned holding device 2 can hold a holder 42 of the torque wrench 4. The holding device has the following features.

The holding device 2 includes a board 21, a swinging body 22, and a sliding body 23. The board 21 is disposed on a moving base 11 of the platform 1. In practice, a connecting board 12 is disposed between the board 21 and the moving base 11 for adjusting the position. The moving base 11 can move close to or away from the driving device 3. This allows the disposition of torque wrenches of different lengths. Moreover, the central part at the top of the board 21 is protruded with an axle element 211.

The swinging body 22 includes a bottom board 221. The central part of the bottom board 221 has an axle hole 221A for the axle element 211 to go through. The axle hole 221A further has bearings 221B. The bearings are mounted on the axle element 211 of the board 21. The swinging body 22 is pivotally disposed on the board 21 using this design. Both sides of the bottom board 221 are vertically disposed with a stop wall 222, respectively. The two stop walls 222 and the bottom board 221 form an accommodating passage 223.

Besides, both sides of the board 21 have at least one stop element 212, respectively. In this embodiment, each of the two sides has three stop elements locked on the connecting board 12 of the moving base 11. The stop elements 212 have a certain distance 213 from the outer side of the stop walls 222 of the swinging body 22. This allows the swinging body 22 to swing. The stop elements 212 urge and block the outer sides of the stop walls 222 when the swinging body 22 swings too much.

The sliding body 23 is disposed on the bottom board 221 of the accommodating passage 223 in a slidable way. The sliding body 23 can slide along the axial direction of the accommodating passage 223. In this embodiment, the sliding body 23 is stopped by the two stop walls 222 to move in the axial direction of the accommodating passage 223. Moreover, the sliding body 23 has a hold opening. 231 for the holder 42 to go through. The sliding body 23 has a fixing structure 230 that can pinch the holder 42. In this embodiment, the fixing structure 230 includes two limiting grooves 233 that are formed in the vertical direction on the sidewalls 232 of the sliding body 23 on both sides of the hold opening 231, and two limiting rods 234 (e.g., round rods) going through the two limiting grooves 233. The surfaces of the two limiting rods 234 that face each other urge against both sides of the holder 42 of the torque wrench 4. The sliding body 23 can move (e.g., slide and deviate) relative to the swinging body 22 inside the accommodating passage 233.

Moreover, one sidewall 232 of the sliding body 23 is horizontally penetrated by a positioning hole 235 toward the limiting groove 233. A positioning element 236 locks in the positioning hole 235 and urges against the side of the limiting rod 234 that is far away from the holder 42. The limiting groove 233 accommodating the limiting rod 234 urged by the positioning element 236 is designed to have a (long) elliptical shape. Therefore, when holding a thicker holder 42, the holding space between the two limiting rods 234 and the holding positions can be appropriately adjusted. Besides, the stop wall 222 on one side of the swinging body 22 is further formed with a through hole 222A corresponding to the positioning hole 235. As a result, an external locking tool can penetrate into the positioning hold 235 through this through hole 222A. This locks and adjusts the urging position of the positioning element 236 on the limiting rod 234.

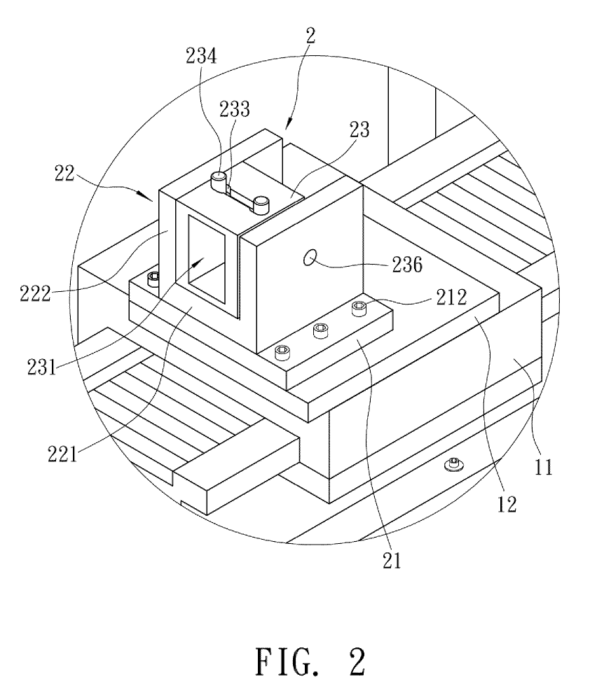

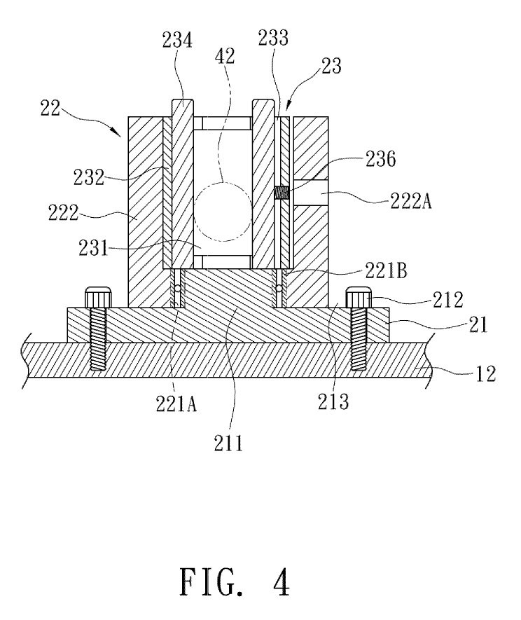

Please refer to FIGS. 2 and 4. Before a test, the holder 42 of the torque wrench 4 is inserted via the hold opening 231 of the sliding body 23. The two limiting rods 234 pinch from both sides of the holder 42. The positioning element 236 is locked to adjust the position where the positioning element 236 urges against the limiting rod 234 and the tightness on the holder 42.

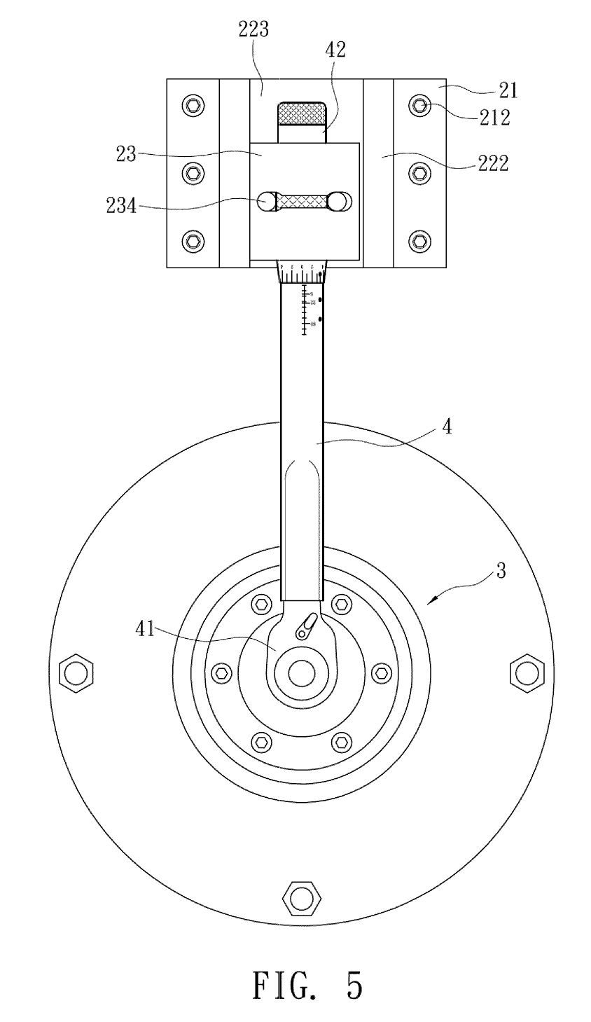

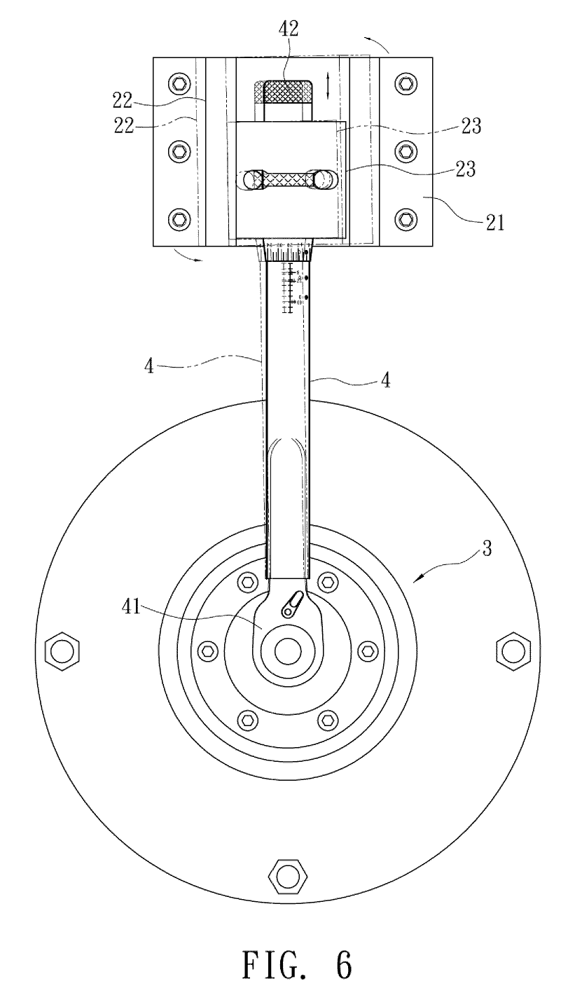

Please refer to FIGS. 4 and 5. During the test, the holder 42 of the torque wrench 4 is held. The sliding body 23 thus deviates and slides to one side of the accommodating passage 223 (e.g., the left side as shown in the drawing). The sidewall 232 of the sliding body 23 urges and pushes the inner side of the stop wall 222 of the swinging body. The swinging body 22 then rotates with respect to the axle element 211, relative to the board 21. As shown in FIGS. 4 and 6, the disclosed holding device allows the holder 42 to have appropriate rotating and sliding behaviors during the test.

In summary, the disclosed holding device can tolerate the rotations, vibrations, and shifts of the torque wrench 4 held by it during a torque test. This is achieved using the rotations, sliding, and displacements of the swinging body 22, the sliding body 23, and the board 21. Therefore, the precision of the platform does not worsen as in the prior art after a long time of use. Moreover, the test errors can be reduced.

Since the holding device disclosed herein can perform rotating and sliding motions, it can better simulate the actual force exertion by human beings. Therefore, the test results are more accurate.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A holding device of a torque tester disposed on a platform with a driving device for the disposition of a working end of a hand tool, with the holding device holding the holder of the hand tool, characterized in that:
the holding device includes at least a swinging body and a sliding body, the swinging body being pivotally installed on the platform for itself to swinging relative to the platform and having an accommodating passage; and
the sliding body slides in the accommodating passage of the swinging body along the axial direction thereof and has a fixing structure for holding the holder of the hand tool.

2. The holding device of a torque tester according to claim 1, wherein a moving base is provided on the side of the platform opposite to the driving device, the holding device is disposed on the moving base, and the moving base moves close to or away from the driving device for adjustments.

3. The holding device of a torque tester according to claim 2 further comprising a board fixed on the moving base of the platform, wherein the top of the board has an axle element corresponding to the moving base; the swinging body has a bottom board with an axle hole for the axle element to go through and for the swinging body to install thereon; both sides of the bottom board have a stop wall, respectively; and the two stop walls and the bottom board form the accommodating passage for the sliding body to slide along the axial direction thereof.

4. The holding device of a torque tester according to claim 3, wherein the sliding body has a hold opening for the holder of the hand tool to go through, the fixing structure has two limiting grooves formed on the two sidewalls on both sides of the hold opening and two limiting rods in the two limiting grooves, with the surfaces of the two limiting rods that face each other urging both sides of the holder, respectively.

5. The holding device of a torque tester according to claim 4, wherein a positioning hole to the limiting groove is formed on the sidewall of the sliding body, and a positioning element locks into the positioning hole and urges against the limiting rod.

6. The holding device of a torque tester according to claim 5, wherein the stop wall of the swinging body has a through hole corresponding to the positioning hole.

7. The holding device of a torque tester according to claim 4, wherein the limiting groove has an elliptical shape.

8. The holding device of a torque tester according to claim 4, wherein the limiting rod is a round rod.
